(19) United States
(12) Patent Application Publication
(10) Pub. No.: US 2009/0249720 A1
(43) Pub. Date: Oct. 8, 2009

(54) PROTECTIVE COVER UNIT AND SEAL UNIT

(75) Inventor: Motohiro Murauchi, Osaka (JP)

Correspondence Address: DITTHAVONG MORI & STEINER, P.C., 918 Prince St., Alexandria, VA, 22314, US

(73) Assignee: Kyoto Intellectual Property Club, Inc., Kyoto-shi (JP)

(21) Appl. No.: 11/997,457

(22) PCT Filed: Jul. 23, 2007
(86) PCT No.: PCT/JP2007/064430

§ 371 Date: Jan. 31, 2008

(30) Foreign Application Priority Data
Jul. 27, 2006 (JP) 2006-205399

(51) Int. Cl. E04B 1/66; F16J 15/02

(52) U.S. Cl. 52/302.7; 277/590

(57) ABSTRACT

A protective cover unit for temporarily sealing an opening 13 of a floor sleeve as a floor remains almost flat includes a disk-like protective cover 3 large enough to cover the opening, an upper compression plate 5 provided under the protective cover 3, fixing water-resistant rubbers 6a, 6b provided under the upper compression plate 5, a lower compression plate 7 provided under the fixing water-resistant rubbers 6a, 6b, and a bolt 1 and nut 8 for integrating the protective cover 3, upper compression plate 5, fixing water-resistant rubbers 6a, 6b and lower compression plate 7. The fixing water-resistant rubbers 6a, 6b seal the opening of the floor sleeve when the protective cover 3, upper compression plate 5, fixing water-resistant rubbers 6a, 6b and lower compression plate 7 are integrated by the bolt 1 and nut 8. The disk-like protective cover 3 and fixing water-resistant rubbers 6a, 6b double-seal the opening of the floor sleeve.

### TECHNICAL FIELD

This invention relates to a protective cover unit and a seal unit, and more particularly to a protective cover unit and a seal unit for protecting openings of floor sleeves or other openings at construction sites or other sites.

### BACKGROUND ART

There are through-holes of varying sizes, which are openings of floor sleeves, in construction sites. These through-holes are previously formed for use in water supply and sewerage systems, electric wiring, air-conditioning and so on.

However, these through-holes have great disadvantages during construction; for example, a stepladder's leg may slip into the through-hole and the stepladder topples, or water used during the construction and rainwater may flow in the through-holes.

Measures to improve the disadvantages are disclosed in Japanese unexamined patent publication Nos. H08-270218 and 2005-060950, for example. According to patent publication No. H08-270218, a sleeve is placed in an opening and is provided with a plate-like protective cover on the upper opening portion of the sleeve. According to patent publication No. 2005-060950, a lid having a predetermined degree of strength and jutting upwardly is placed on an opening to close the upper surface of the opening. In some other cases, instead of a plate covering the opening, a veneer that is cut out into the size of the opening of a floor sleeve is put on the opening of the floor sleeve, and concrete nails and so on are used to secure the veneer to prevent slippage. When the veneer is used, the periphery of the veneer is caulked with silicon or the veneer is surrounded by a mortar bank to prevent water entry.

However, the protective cover according to patent publication No. H08-270218 is a plate that can keep the floor flat, but has no strength, therefore causing the leg of the stepladder to drop therein or rainwater or the like to flow therein upon breakage of the plate due to a heavy load as in conventional cases. The strong and upwardly jutting lid according to patent publication No. 2005-060950 covers the opening without problem even if a heavy load is put on the opening; however, such an upwardly jutting lid makes it difficult for carts to move around because the lid makes the floor uneven. The conventional veneer protective cover that is required to be formed on the site involves a lot of process steps and considerable material cost, and the expensively formed protective cover becomes unnecessary after construction.

In addition, many of the protective covers made of the veneer are broken or lose their proper water-resistant functions by passage of vehicle-mounted aerial work platforms and carts, whereby entailing high cost for reproducing and repairing the protective covers. Furthermore, the mortar used to prevent water entry, veneer scraps and used protective veneer covers are treated as industrial waste.

### DISCLOSURE OF THE INVENTION

This invention is made to solve the above problems and has an object to provide a protective cover unit and seal unit having load-bearing characteristics to withstand a heavy load such as a cart passing thereon, having excellent water sealing properties and being reusable.

The protective cover unit according to the present invention is used to temporarily seal an opening of a floor sleeve as a floor remains almost flat. The protective cover unit includes a protective cover large enough to cover the opening, an upper compression plate provided under the protective cover, a fixing water-resistant rubber provided under the upper compression plate, a lower compression plate provided under the fixing water-resistant rubber, and a bolt and a nut for integrating the protective cover, upper compression plate, fixing water-resistant rubber and lower compression plate. When the protective cover, upper compression plate, fixing water-resistant rubber and lower compression plate are integrated by the bolt and nut, the fixing water-resistant rubber seals the opening of the floor sleeve, and the protective cover and fixing water-resistant rubber double-seal the opening of the floor sleeve.

In the protective cover unit according to the present invention, the protective cover sealing the opening of the floor sleeve has load-bearing characteristics to withstand a heavy load such as a cart passing thereon. In addition, the fixing water-resistant rubber that also seals the opening of the floor sleeve provides excellent water sealing properties.

As a result, the protective cover unit, which has load-bearing characteristics and excellent water sealing properties and is reusable, can be provided.

Preferably, the protective cover has an oblong hole through which the bolt passes.

More preferably, the protective cover unit includes a plurality of the fixing water-resistant rubbers.

Each of the plurality of fixing water-resistant rubbers has a through-hole through which the bolt passes. The through-holes formed in the plurality of fixing water-resistant rubbers are different in size.

In another aspect of the present invention, the seal unit seals an opening. The seal unit includes a cover large enough to cover the opening, an upper compression plate provided under the cover, a fixing rubber provided under the upper compression plate, a lower compression plate provided under the fixing rubber, and a bolt and a nut for integrating the cover, upper compression plate, fixing rubber and lower compression plate. The fixing rubber seals the opening when the cover, upper compression plate, fixing rubber and lower compression plate are integrated by the bolt and nut, and the cover and fixing rubber double-seal the opening

### BRIEF DESCRIPTION OF THE DRAWINGS

FIG. 1 is an exploded front view of a protective cover unit according to an embodiment of the present invention.

FIG. 2 illustrates a usage state of the protective cover unit.

FIG. 3 illustrates a usage state of the protective cover unit.

FIG. 4 illustrates a usage state of the protective cover unit.

FIG. 5 is a plan view of main components making up the protective cover unit.

FIG. 6 illustrates a usage state of the protective cover unit positioned away from a wall.

FIG. 7 illustrates a usage state of the protective cover unit adjacent to the wall.

FIG. 8 illustrates a usage state of a seal unit according to an embodiment of the present invention.

### BEST MODE FOR CARRYING OUT THE INVENTION

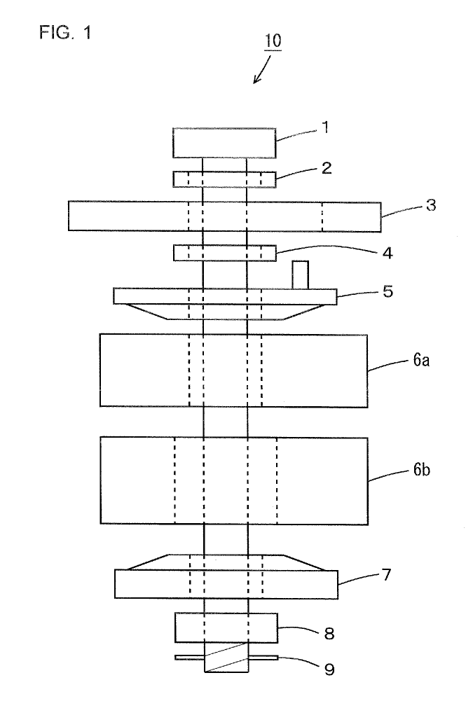

An embodiment of the present invention will be now described by referring to the drawings. FIG. 1 is an exploded front view of the protective cover unit according to the embodiment of the invention. Referring to FIG. 1, a protective cover unit 10 includes a bolt 1 and a nut 8 placed vertically, and also includes a washer 2, a disk-like protective cover 3, a packing 4, an upper compression plate 5, fixing water-resistant rubbers 6a and 6b, a lower compression plate 7 arranged in this order between the head of the bolt 1 and nut 8. At the lowermost part of the bolt 1, a drop-prevention pin 9 is provided to prevent the nut 8 from dropping.

As the bolt 1 is tightened, the nut 8 ascends and the fixing water-resistant rubbers 6a, 6b sandwiched between the upper compression plate 5 and lower compression plate 7 are compressed and swollen laterally. The fixing water-resistant rubbers 6a, 6b are fixed at an opening of a floor sleeve (not shown) by bracing themselves against the opening and prevent water from entering the floor sleeve.

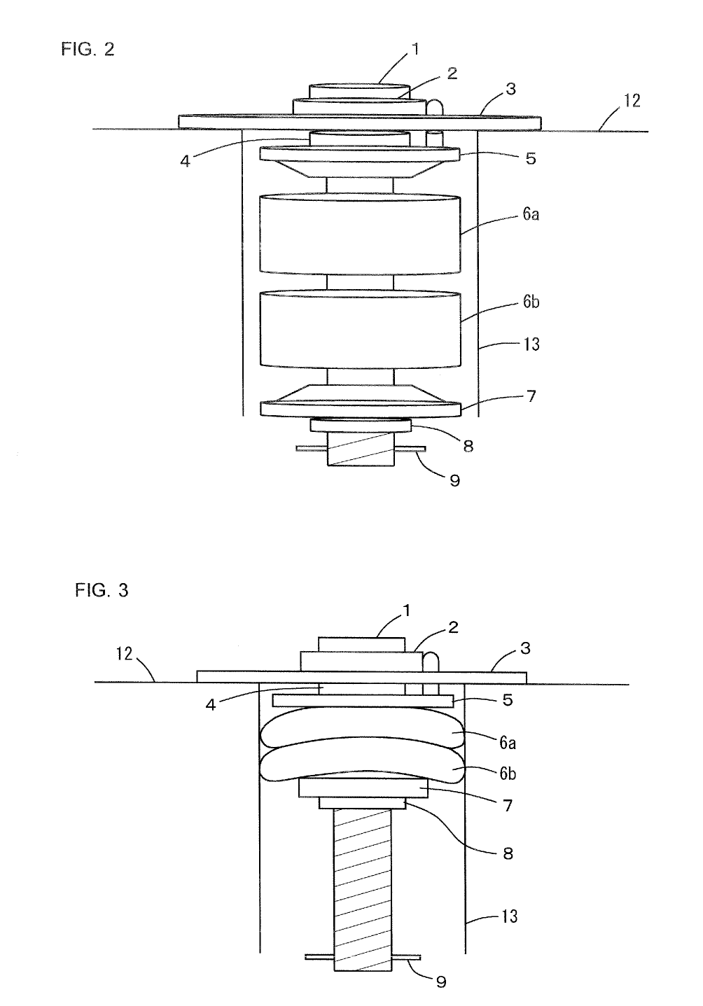

FIGS. 2 to 4 illustrate a series of steps of installing the protective cover unit 10 of the embodiment. First, as shown in FIG. 2, the protective cover unit 10 is inserted into a through-hole (an opening of a floor sleeve) 13 of a floor 12 on the construction site. The inserted protective cover unit 10 has the protective cover 3 alone on the floor 12 and other components thereunder fitting in the through-hole 13 of the floor sleeve. As the bolt 1 is tightened with the protective cover unit 10 being in the position, the nut 8 goes up and the fixing water-resistant rubbers 6 are laterally swollen as shown in FIG. 3, thereby fixing the protective cover unit 10 at the opening 13 of the floor sleeve and stopping water entry.

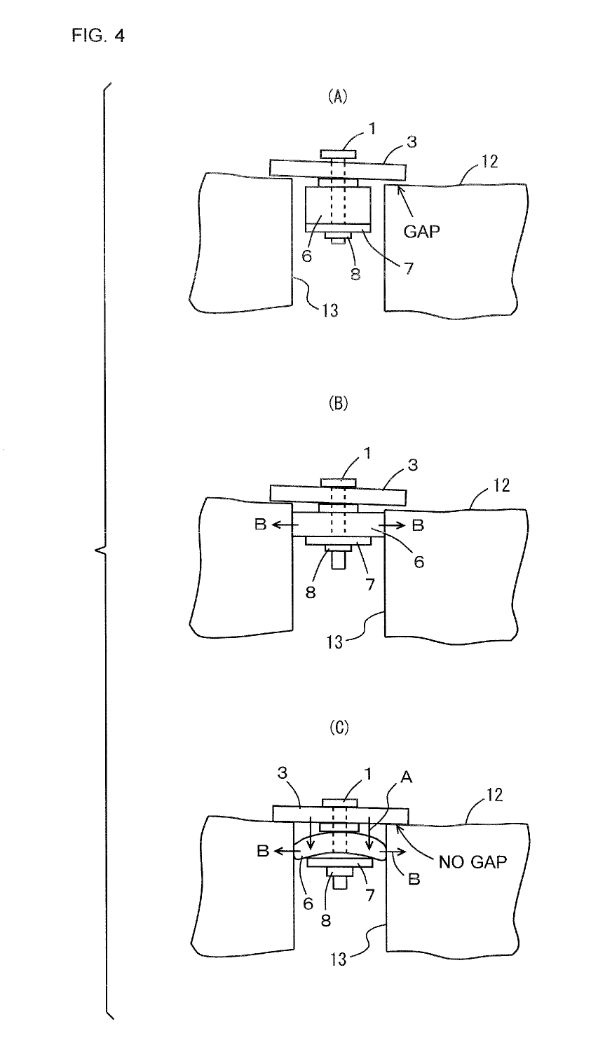

FIG. 4 illustrates the behaviors of the protective cover unit 10 when it is double-fixed on the floor 12 and in the opening 13 of the floor sleeve for the sake of clarity. FIG. 4 (A) corresponds to FIG. 2, FIG. 4 (C) corresponds to FIG. 3, and FIG. 4 (B) illustrates the state of the protective cover unit 10 between FIG. 4 (A) and FIG. 4 (C). It should be noted that FIG. 4 illustrates the fixing water-resistant rubbers 6a, 6b as an integrated component 6 and small parts such as the washer are omitted. In addition, FIG. 4 is exaggerated for the purpose of making it easy to understand.

Referring to FIG. 4 (A), there is a gap between the protective cover 3 and floor 12 after the protective cover unit 10 is just inserted through the opening 13 of the floor sleeve. Referring to FIG. 4 (B), tightening the bolt 1 ascends the nut 8, and the fixing water-resistant rubber 6 sandwiched between the upper compression plate 5 and lower compression plate 7 is compressed and swollen laterally as indicated by arrow B, and therefore the fixing water-resistant rubber 6 is braced in the opening 13 of the floor sleeve to be fixed and prevent water entry.

The nut 8 moved up by further tightening the bolt 1 pulls up only the center part of the fixing water-resistant rubber 6 with its outer edge being pressed and fixed at the opening 13 of the floor sleeve as shown in FIG. 4 (C). Since the uplifted center part of the fixing water-resistant rubber 6 is elastically deformed, the resilience pulls down the protective cover 3 as indicated by arrow A.

As a result, the fixing water-resistant rubber 6 in the opening 13 of the floor sleeve prevents water entry and fixes itself, while the protective cover 3, which is pulled down by the fixing water-resistant rubber 6 and therefore is in absolute contact with the floor 12 without the gap, prevents water from entering from the floor 12 and fixes itself on the floor 12. By the above actions, the protective cover unit 10 can double-seal the opening 13 of the floor sleeve.

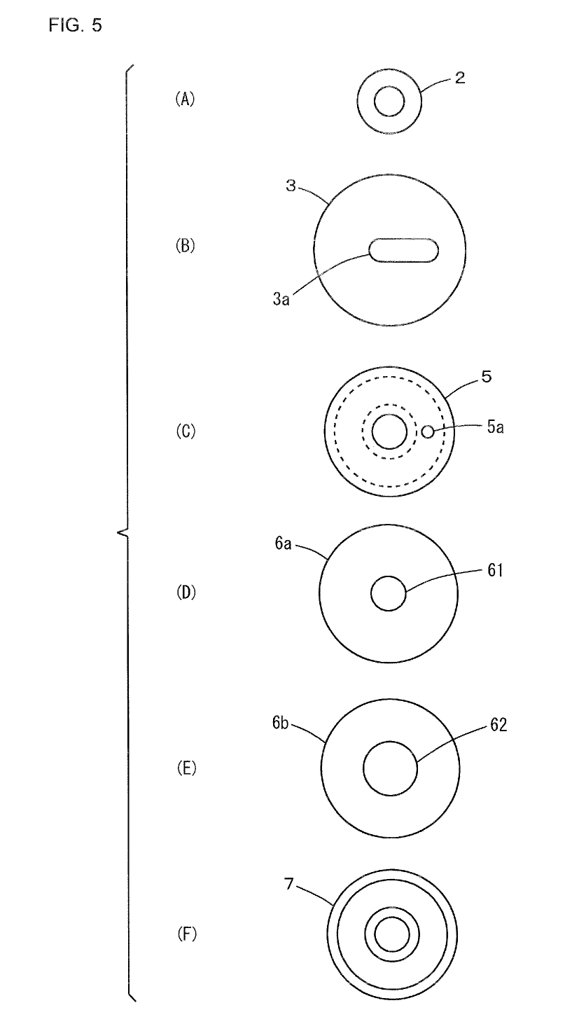

Next, a description will be made about individual components making up the protective cover unit 10. FIG. 5 is a plan view of the individual components making up the protective cover unit 10. FIG. 5 (A) is a plan view of the washer 2; FIG. 5 (B) is a plan view of the protective cover 3; FIG. 5 (C) is a plan view of the upper compression plate 5; FIG. 5 (D) is a plan view of the fixing water-resistant rubber 6a; FIG. 5 (E) is a plan view of the fixing water-resistant rubber 6b; and FIG. 5 (F) is a plan view of the lower compression plate 7. It should be noted that a plan view of the packing 4 is omitted since it is the same as the washer 2 shown in FIG. 5 (A).

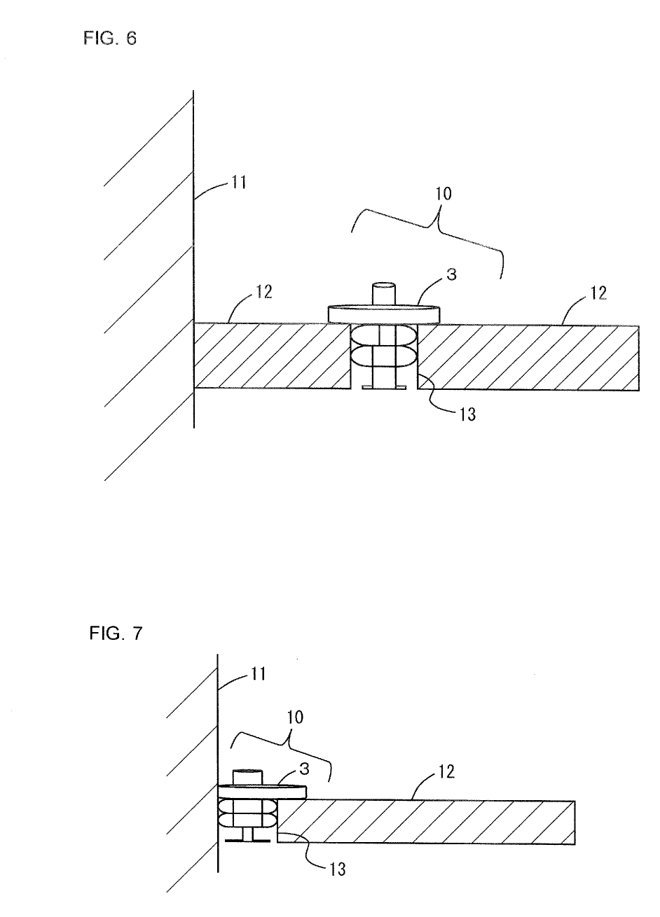

Referring to FIG. 5 (B), the protective cover 3 has a center hole 3a through which the bolt passes in the shape of not a circle but an oblong. There is a reason for the shape. When the opening 13 of the floor sleeve is located away from a wall 11 as shown in FIG. 6, the protective cover 3 can he used by passing the bolt 1 through the center of the protective cover 3. In this case, the hole of the bolt can be a circle in the center of the cover. On the other hand, when the opening 13 of the floor sleeve is located adjacent to the wall 11 as shown in FIG. 7, the protective cover 3 having only a circular hole in its center interferes with the wall 11, and therefore the protective cover unit 10 cannot be attached to the opening 13 of the floor sleeve. In this embodiment, the protective cover 3 is provided with an oblong hole 3a so that the protective cover unit 10 can be attached to the opening 13 of the floor sleeve even under such a circumstance, specifically even if the bolt 1 of the protective cover unit 10 is eccentric.

Referring to FIG. 5 (C), the upper compression plate 5 has a detent 5a on its upper part. This detent 5a is engaged in the oblong hole 3a of the protective cover 3 to arrest the rotation of the protective cover 3. In addition, as shown in FIG. 1, the lower part of the upper compression plate 5 is tapered toward the fixing water-resistant rubber 6 positioned under the upper compression plate 5. The tapered lower part helps the upper part of the fixing water-resistant rubber 6 swell laterally when the bolt 1 is tightened. Similarly, the upper part of the lower compression plate 7 is upwardly tapered, and helps the lower part of the fixing water-resistant rubber 6 swell laterally. The tapered parts can be omitted to slim down the cost of the tapering process. Even if the tapered parts are omitted, the fixing water-resistant rubber 6 is swollen laterally with a strong compression force, thereby functioning as a fixture and water-seal.

As shown in FIGS. 5 (D) and (E), the fixing water-resistant rubber 6 is separated into two parts in this embodiment. The upper fixing water-resistant rubber 6a has a through-hole 61 having a predetermined diameter in the center thereof, while the fixing water-resistant rubber 6b has a through-hole 62 having a diameter larger than the through-hole 61 in the center thereof. Provision of the two fixing water-resistant rubbers 6a, 6b ensures reliable fixing and prevention of water from entering therein. The fixing water-resistant rubber 6b having the larger hole through which the bolt passes can be eccentric in a modest range because the wall surface of the opening 13 of the floor sleeve is uneven.

The washer 2 in FIG. 5 (A) and packing 4 (not shown) are provided to prevent water droplets from coming down along the bolt 1. The drop-prevention pin 9 is provided as a safeguard to prevent the nut 8 from dropping as mentioned above.

It is preferable to fix the nut 8 to the lower compression plate 7. This can prevent the nut 8 from turning free since the detent mechanism of the upper compression plate 5 acts on the nut 8 through the fixing water-resistant rubber 6 having great friction with the upper compression plate 5 and the lower compression plate 7 having great friction with the fixing water-resistant rubber 6.

In the embodiment, the protective cover 3 is made of an iron plate, but any other material is available if only it is inexpensive and robust. As mentioned above, the conventional protective cover is often damaged by passage of carts or while repairing for inadequate water resistance. The breakage of the protective cover adversely affects safety significantly. In addition, the breakage causes an increase in man-hours for the repair. However, the protective cover according to the embodiment is versatile and therefore can be manufactured in advance. Thus, the protective cover can be made of an iron plate which is intractable at construction sites, thereby improving safety greatly.

Although the protective cover is a disk-like plate in the above embodiment, the protective cover is not limited to this and can be an oval or polygon shape as long as it is large enough to cover the opening of the floor sleeve.

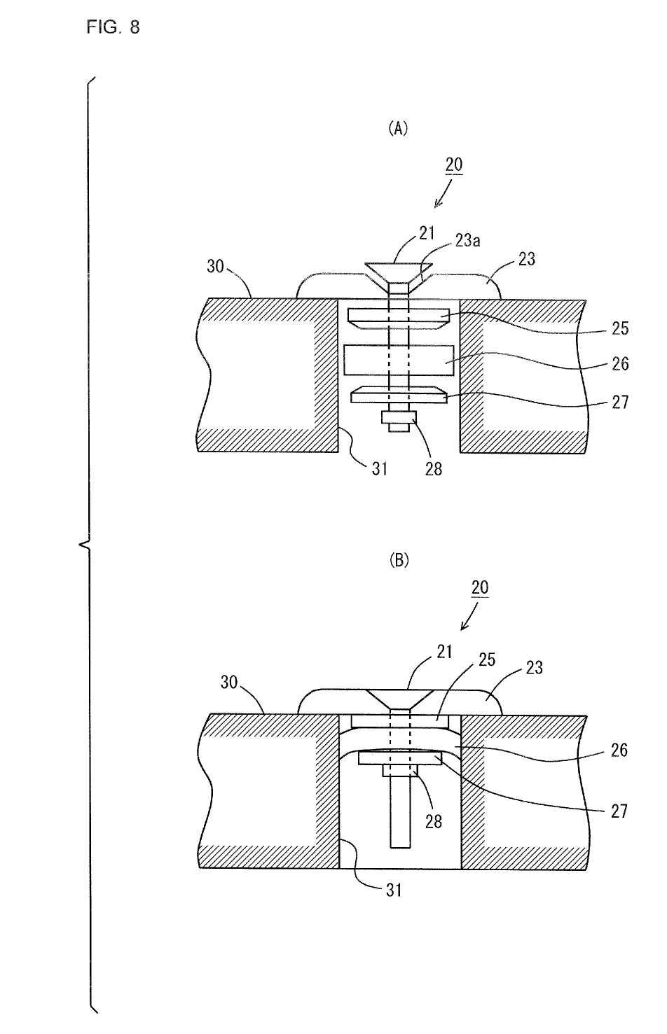

Next, a description will be made about another embodiment of the present invention. The description of the above embodiment is about a protective cover unit used to temporarily seal the opening of the floor sleeve as the floor remains almost flat. The same structure can be used as a seal unit for sealing, for example, an opening of a table or the like. FIG. 8 illustrates an example of the seal unit used to seal an opening of a table. FIGS. 8 (A) and 8 (B) correspond to FIGS. 4 (A) and 4 (C), respectively. A table 30 has an opening 31 to which desired equipment is attached. To seal the opening 31 a seal unit 20 is used.

Referring to FIGS. 8 (A) and 8 (B), the seal unit 20 includes a cover 23 large enough to cover the opening 31, an upper compression plate 25 provided under the cover 23, a fixing rubber 26 provided under the upper compression plate 25, a lower compression plate 27 provided under the fixing rubber 26, and a bolt 21 and nut 28 for integrating the cover 23, upper compression plate 25, fixing rubber 26 and lower compression plate 27. When the cover 23, upper compression plate 25, fixing rubber 26 and lower compression plate 27 are integrated by the bolt 21 and nut 28, the opening 31 is sealed by the cover 23 and fixing rubber 26. That is to say, the cover 23 and fixing rubber 26 double-seal the opening 30.

In this embodiment, the bolt 21 is a countersunk bolt, and the cover 23 has a tapered concave 23a, in the center thereof, into which the countersunk head of the countersunk bolt 23 fits well and is in the shape of a circle with an upper part chamfered. In addition, the seal unit that has an entire length less than the depth of the opening 31 is useable to seal holes of something required to be aesthetically pleasing and safe, such as the table.

The seal unit 20 also can include the cover having an oblong hole through which the bolt passes and a plurality of fixing rubbers. The plurality of fixing rubbers have through-holes through which the bolt passes, and the through-holes of the plurality of fixing rubbers can be different in size.

Furthermore, the seal unit can be used to seal not only holes of furniture, such as a table, but also any through-holes. The shape of the cover, the general dimension of the seal unit and so on can be modified according to places to which the seal unit is applied.

The foregoing has described the embodiments of the present invention by referring to the drawings. However the invention should not be limited to the illustrated embodiments. It should be appreciated that various modifications and changes can be made to the illustrated embodiments within the scope of the appended claims and their equivalents.

### INDUSTRIAL APPLICABILITY

The protective cover unit according to the present invention that fixes itself to the floor sleeve and prevents water entry with reliability is advantageously used.

What is claimed is:

1. A protective cover unit temporarily sealing an opening of a floor sleeve as a floor remains almost flat, comprising:
a protective cover large enough to cover said opening;
an upper compression plate under said protective cover;
a fixing water-resistant rubber under said upper compression plate;
a lower compression plate under said fixing water-resistant rubber; and
a bolt and a nut for integrating said protective cover, upper compression plate, fixing water-resistant rubber and lower compression plate, wherein
said fixing water-resistant rubber seals the opening of said floor sleeve when said protective cover, upper compression plate, fixing water-resistant rubber and lower compression plate are integrated by said bolt and nut, and
said protective cover and said fixing water-resistant rubber double-seal the opening of said floor sleeve.

2. The protective cover unit according to claim 1, wherein
said protective cover has an oblong hole through which said bolt passes.

3. The protective cover unit according to claim 1, wherein
said protective cover unit comprises a plurality of said fixing water-resistant rubbers.

4. The protective cover unit according to claim 3, wherein
each of said plurality of fixing water-resistant rubbers has a through-hole through which the bolt passes, and
said through-holes of said plurality of fixing water-resistant rubbers are different in size.

5. A seal unit sealing an opening, comprising:
a cover large enough to cover said opening;
an upper compression plate under said cover;
a fixing rubber under said upper compression plate;
a lower compression plate under said fixing rubber; and
a bolt and a nut for integrating said cover, upper compression plate, fixing rubber and lower compression plate, wherein
said fixing rubber seals said opening when said cover, upper compression plate, fixing rubber and lower compression plate are integrated by said bolt and nut, and
said cover and said fixing rubber double-seal said opening.
